(19) United States
(12) Patent Application Publication
(10) Pub. No.: US 2006/0005146 A1
(43) Pub. Date: Jan. 5, 2006

(54) System and method for using selective soft focus as a user interface design element

(76) Inventor: Blaise Aguera y Arcas, Seattle, WA (US)

Correspondence Address: KAPLAN GILMAN GIBSON & DERNIER L.L.P., 900 ROUTE 9 NORTH, WOODBRIDGE, NJ, 07095, US

(21) Appl. No.: 11/172,393

(22) Filed: Jun. 30, 2005

Related U.S. Application Data
(60) Provisional application No. 60/585,157, filed on Jul. 1, 2004.

(51) Int. Cl. G06F 3/00

(52) U.S. Cl. 715/802

(57) ABSTRACT

A method is disclosed which may include providing a display operating within a computing system; selecting at least one display characteristic to represent respective activity statuses of a plurality of windows present in the display, the at least one display characteristic including at least resolution; and displaying the windows employing values of the at least one selected display characteristic corresponding to the windows' respective activity statuses.

### REFERENCE TO RELATED APPLICATIONS

This application claims the benefit of U.S. Provisional Patent application Ser. No. 60/585,157, filed Jul. 1, 2004, entitled “Use of Selective Soft Focus as a User Interface Design Element,” the entirety of the disclosure of which application is incorporated herein by reference.

### BACKGROUND OF THE INVENTION

Most present-day computer windowing systems (including, for example, Apple's OS X®, Microsoft Windows®, and X windows® on Unix) define windows on the screen as the basic user interface element. Often these windows can be independently moved, resized, hidden or exposed, etc. Different applications running concurrently on the computer generally occupy different windows. Herein, the term “window” may include icons, menus and/or other individual graphical elements on the computer display.

When using a windowing system, a computer user generally directs attention to one window at a time among windows visible on a computer screen, this window being referred to herein as the “active window.” The other windows on the computer screen may be referred to herein as “inactive windows.” Windowing systems generally distinguish between active and inactive windows by directing keyboard input and other user activity only the active window and not to the remainder of the windows visible on the computer screen.

The two most common methods for changing the window having the active status are practiced in Microsoft Windows®. In that program, a window is made active when a user clicks on the window using the mouse cursor. In X Windows®, a window may be made active by moving a computer mouse over the window.

Using existing application programs, windows are generally presented substantially the same way whether the windows are active or inactive. This approach tends to reduce the visual distinction between active and inactive windows. Moreover, this approach imposes substantially the same computational burden on a computing system to render a window whether the window is active or not. Accordingly, there exists a need in the art for an improved system and method for rendering windows on computer screens.

### SUMMARY OF THE INVENTION

According to one aspect, the invention may provide a method, comprising: providing a display operating within a computing system; selecting at least one display characteristic to represent respective activity statuses of a plurality of windows present in the display, the at least one display characteristic including at least resolution; and displaying the windows employing values of the at least one selected display characteristic corresponding to the windows' respective activity statuses. Preferably, the at least one display characteristic further includes at least one characteristic selected from the group consisting of: contrast, brightness, color balance, and saturation. Preferably, the method further comprises increasing a value of the at least one display characteristic for a given one of the windows when an activity status of the given window transitions from inactive to active. Preferably, the increasing comprises: gradually increasing the value of the at least one display characteristic. Preferably, the increasing the value of the at least one display characteristic comprises providing a high-resolution display of the given window.

Preferably, the method further comprises reducing a value of the at least one display characteristic for a given one of the windows when an activity status of the given window transitions from active to inactive. Preferably, the reducing comprises gradually reducing the value of the at least one display characteristic for the given one of the windows. Preferably, the reducing comprises providing a low-resolution display of the given window. Preferably, the providing a low-resolution display of the given window lowers a computational burden on the computing system imposed by the displaying.

According to another aspect, the invention may provide a method, comprising providing a display operating within a computing system; displaying a plurality of windows on the display, at least one of the windows being an active window; making the at least one active window inactive; reducing a display resolution of the at least one window upon the making the at least one window inactive. Preferably, the method further comprises maintaining the at least one window at the lowered resolution for as long as the at least one window is inactive. Preferably, the reducing comprises gradually reducing the display resolution of the at least one window. Preferably, the plurality of windows includes at least one initially inactive window. Preferably, the method further comprises making one of the at least one initially inactive window active; and increasing a display resolution of the one window. Preferably, the increasing comprises gradually increasing the display resolution of the one window. Preferably, the method further comprises discontinuing processing in an application program controlling the at least one deactivated window.

According to another aspect, the invention may provide an apparatus, comprising: a computing system having a display, wherein the computing system is operable to select at least one display characteristic to represent respective activity statuses of a plurality of windows present in the display, the at least one display characteristic including at least resolution; and display the windows employing values of the at least one selected display characteristic corresponding to the windows' respective activity statuses. Preferably, the at least one display characteristic further includes at least one characteristic selected from the group consisting of: contrast, brightness, color balance, and saturation. Preferably, the computing system is further operable to: increase a value of the at least one display characteristic for a given one of the windows when an activity status of the given window transitions from inactive to active. Preferably, the computing system is further operable to: reduce a value of the at least one display characteristic for a given one of the windows when an activity status of the given window transitions from active to inactive.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a diagram of a display image including three windows having different values of a display characteristic in accordance with one or more aspects of the present invention;

FIG. 2 is a diagram of the display image of FIG. 1 in which a new active window has been selected in accordance with one or more embodiments of the present invention;

FIG. 3 is an exemplary diagram of two windows within a computer display in accordance with one or more embodiments of the present invention;

FIG. 4 is a diagram of the computer display of FIG. 3 in which a new window has become active in accordance with one or more embodiments of the present invention; and

FIG. 5 is a block diagram of a computing system adaptable for use with one or more embodiments of the present invention.

### DETAILED DESCRIPTION OF THE PREFERRED EMBODIMENTS

In one or more embodiments of the present invention, the visual disparity between an active window and inactive windows may be enhanced by causing one or more display characteristics to vary between active and inactive windows. The disparity in display characteristics between the active window and one or more inactive windows may be present for as long as any inactive windows are present on a computer screen.

In many situations, a computer display, at any one time, may display only one active window and a plurality of inactive windows. However, the present invention is not limited to this arrangement. There may be no inactive window, a single inactive window, or a plurality of inactive windows, and all such variations are intended to be included within the scope of the present invention.

In one or more embodiments, transitions in the displayed values of display characteristics between inactive windows and active windows may be implemented gradually, thereby simulating the effect of continuously changing the focus of an optical instrument such as a camera or telescope.

In one or more embodiments, the edges (alternatively to or in addition to the interiors) of inactive windows may have their display characteristics altered with respect to the display characteristics of the active window. For instance, the inactive windows may be blurred, thereby providing an out-of-focus character of the displayed inactive window. The out-of-focus effect may be further enhanced in various ways, including by employing sudden or gradual changes in resolution, brightness, contrast, saturation or color balance relative to the display characteristics of active windows.

In addition to making active and inactive windows more readily visually distinguishable from one another, one or more embodiments of the present invention may also provide significant computational benefits. For instance, a blurry image may be rendered by interpolating a lower-resolution image.

Therefore, if rendering windows on the display imposes a computational burden that increases (whether proportionally or not) with an increasing number of image samples being rendered and/or with an increasing resolution of each rendered image, this burden could be decreased by rendering one or more images at a low resolution. Thereafter, if the computer system may interpolate (or “up-sample”) the low-resolution rendition to display a high resolution image.

In one or more embodiments, the lower-resolution rendering could be employed to render an inactive version of a window, and the up-sampled, higher-resolution version of that image could be employed to render an active version of the window. A final up-sampling operation could be hardware-accelerated on many graphics platforms, making it a zero-cost operation for the CPU. In one or more alternative embodiments, however, the upsampling could be performed entirely in software. While the foregoing discussion is directed to the use of the display characteristic of resolution to distinguish between active and inactive windows, it will be appreciated by those of ordinary skill in the art that one or more other display characteristics could be used in addition to, or instead of, resolution to distinguish between active and inactive windows. The above concepts are discussed in the context of the following examples.

In one or more embodiments, a display (which may be a computer screen) on a computing system may initially be blank. Preferably, a first application program is executed, and a first window belonging to and controlled by this first application program is displayed on the screen. This window, being the only one displayed on the screen, is preferably active.

Thereafter, additional windows are preferably added to the screen, which may belong to the first application program, mentioned above, or which may belong to other application programs. For the sake of this discussion, it is assumed that once various windows have been displayed on the screen, belonging to one or more application programs, the screen is thereafter populated by a plurality of windows, one of which is active, and the rest inactive. Herein, the active window is the window on the screen which may receive data from the computer mouse, keyboard, and/or other user data entry devices. Generally, all the other windows on the screen are inactive. Herein, each window has an “activity status” which status may be active or inactive. Moreover, a window may undergo a transition between these two activity statuses in either direction. Herein, a window that has been made active has been “activated,” and a window that has been made inactive has been “deactivated.”

In one or more embodiments, a window having an active status may be distinguished from one or more inactive windows by being displayed using a different value of one or more display characteristics. Such display characteristics may include but are not limited to resolution, contrast, brightness, color balance, and saturation. The computing system controlling the computer screen may select one or more display characteristics to vary in order to suitably distinguish an active window from one or more inactive windows displayed on the screen.

For the display characteristics of resolution, contrast, brightness, and saturation, the meanings of “increasing” and “decreasing” the values of such characteristics are readily understood. In the case of “color balance” the “value” of this display characteristic may correspond to one or more of the R (red), G (green), and B (blue) values of the RGB setting for the window concerned. Thus, once established, one or more of these color values may be varied (i.e. increased or decreased), either alone, or in combination with one or more other display characteristics, to distinguish between active and inactive windows.

In one or more embodiments, higher values of one or more display characteristics may be employed for displaying the active window, and lower values may be employed for displaying one or more inactive windows. However, in one or more alternative embodiments, this arrangement may be reversed for one or more of the display characteristics employed. For instance, in one or more embodiments, an active window could be displayed using a high value of brightness and a low value of contrast, and the inactive windows could be displayed using a lower value of brightness and a higher value of contrast (the terms “higher” and “lower” for the values of the display characteristics of the inactive window are relative to the values of the respective display characteristics used for the active window). All of the foregoing variations are intended to be included within the scope of the present invention.

By way of example, the display characteristics of resolution and brightness may be employed to distinguish between active and inactive windows being displayed on a computer screen. In this example, the active window may be displayed using high values of both resolution and brightness. Consistent with the foregoing, one or more inactive windows may be displayed using lower values of resolution and brightness than are used in the display of the active window.

In one or more embodiments, one or more events may cause a change in the activity statuses of one or more windows displayed on a computer screen. Generally, when an initially inactive window becomes active, the previously active window becomes inactive.

In one or more embodiments, values of one or more of the display characteristics of the active window change as it is deactivated. This transition in display characteristics may occur abruptly or gradually. A gradual transition may aid in illustrating the occurrence of the change to a computer user. The computing system controlling the transition may select a time period within which such a gradual change occurs within. While a gradual transition between starting and ending display characteristic values may occur within any selected time period, a preferred transition period may be about two seconds or less. However, transition periods shorter than or longer than two seconds may be employed.

Continuing with the example discussed above, when a previously inactive window among the windows displayed on the computer screen becomes active, the values of the resolution and brightness of the previously active window preferably transition down to “inactive” levels. Conversely, the values of resolution and brightness of the newly active window preferably transition up to the “active” levels. In both cases, the transitions may be either abrupt or gradual.

Continuing with the above example, a case is considered in which a gradual transition is employed using a time period of about one second. In this case, the brightness and resolution of the window undergoing a transition from “active” to “inactive” levels of its display characteristics may change gradually over this one-second transition period. Preferably, another window undergoing the transition from inactive to active undergoes the reverse transition over substantially the same time period. Preferably, during this transition period, the ongoing change in the display characteristics of both windows undergoing transition is operable to prominently display for the computer user the change in the activity statuses occurring for the two windows concerned.

Once a given window has undergone a transition to an active status or to an inactive status, the given window preferably maintains this status until another status-changing event occurs. Consequently, the values of the display characteristics associated with this maintained status are preferably also maintained.

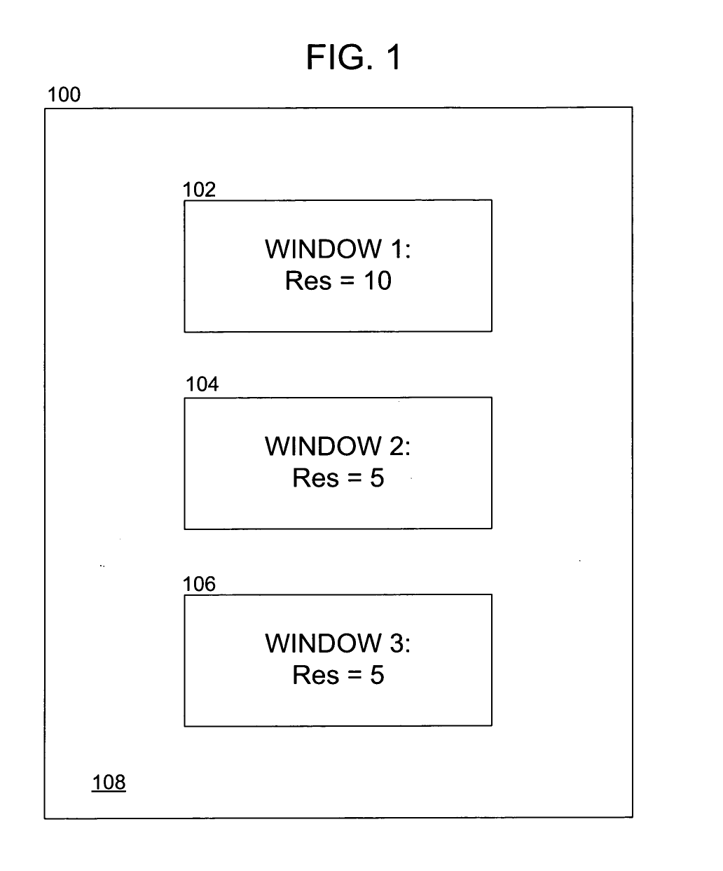

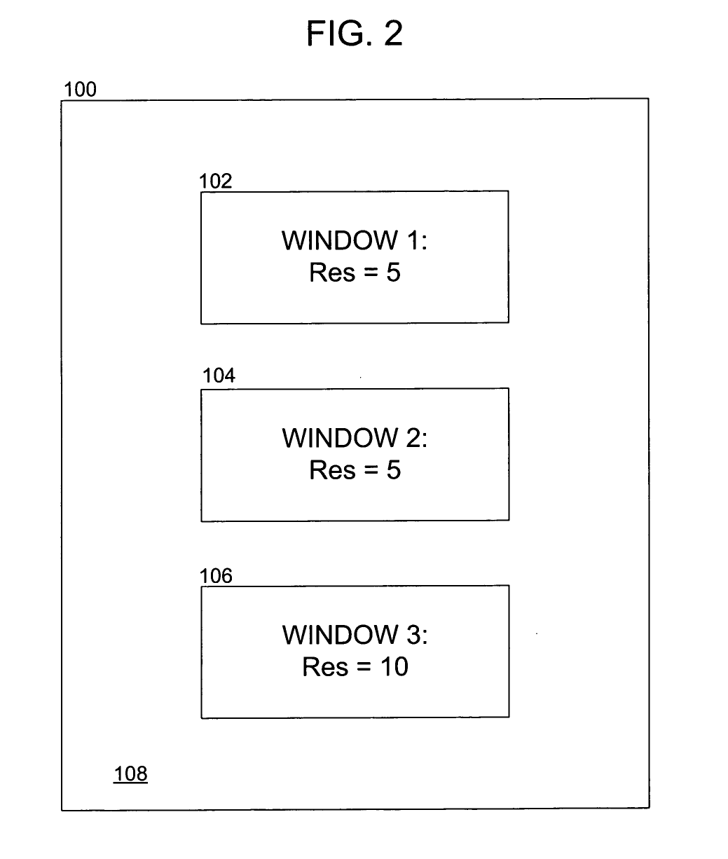

The following example illustrates the concepts discussed above. Reference is made to FIGS. 1 and 2 in the following. FIG. 1 is a diagram of display image 108 on a computer display 100 including three windows 102, 104, 106 having different values of a display characteristic in accordance with one or more aspects of the present invention. FIG. 2 is a diagram of the display image 108 of FIG. 1 in which a new active window has been selected in accordance with one or more embodiments of the present invention.

With reference to FIG. 1, image 108 may include window 1 102, window 2 104, and window 2 106. In this example, the display characteristic of resolution may be used to illustrate the activity statuses of the windows. However, one or more other display characteristics could be employed for this purpose, either in addition to or in place of, the use of image resolution. In the following, a generic set of resolution units is used for the sake of discussion. The number used does not necessarily correspond to a concentration of screen pixels within a defined linear distance on the screen. Thus, the differences in resolution between the various windows 102, 104, and 106 are expressed only in terms of the numerical value of the variable “res.” The printouts of FIGS. 1 and 2 do not actually illustrate the windows in the drawing using different resolutions.

Continuing with the example, in FIG. 1, window 1 102 is preferably the active window, having a resolution value of Res=10. Window 2 104 and window 3 106 are preferably inactive windows, each having resolution values of 5. Turning to FIG. 2, it may be seen that window 1 102 has transitioned from the active state to the inactive state, now having a resolution value of 5. Also, initially inactive window 3 106 has transitioned from the inactive state to the active state, now having a resolution value of 10. As discussed more generally earlier in this disclosure, the transitions from active to inactive and vice versa may be conducted either abruptly or gradually.

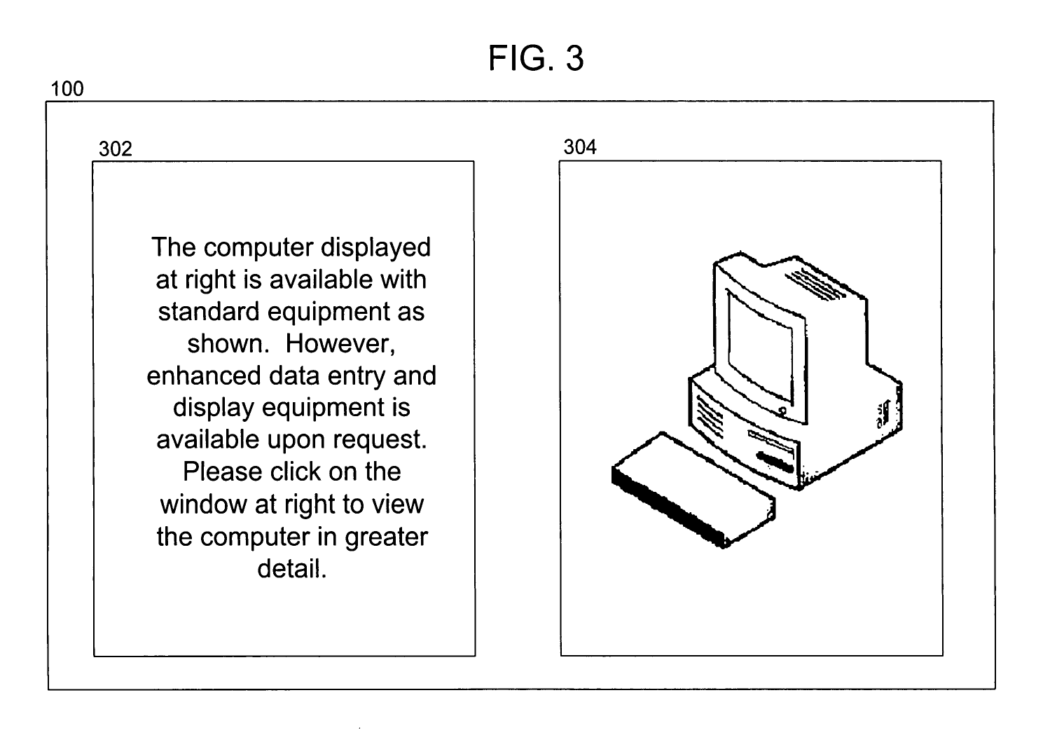

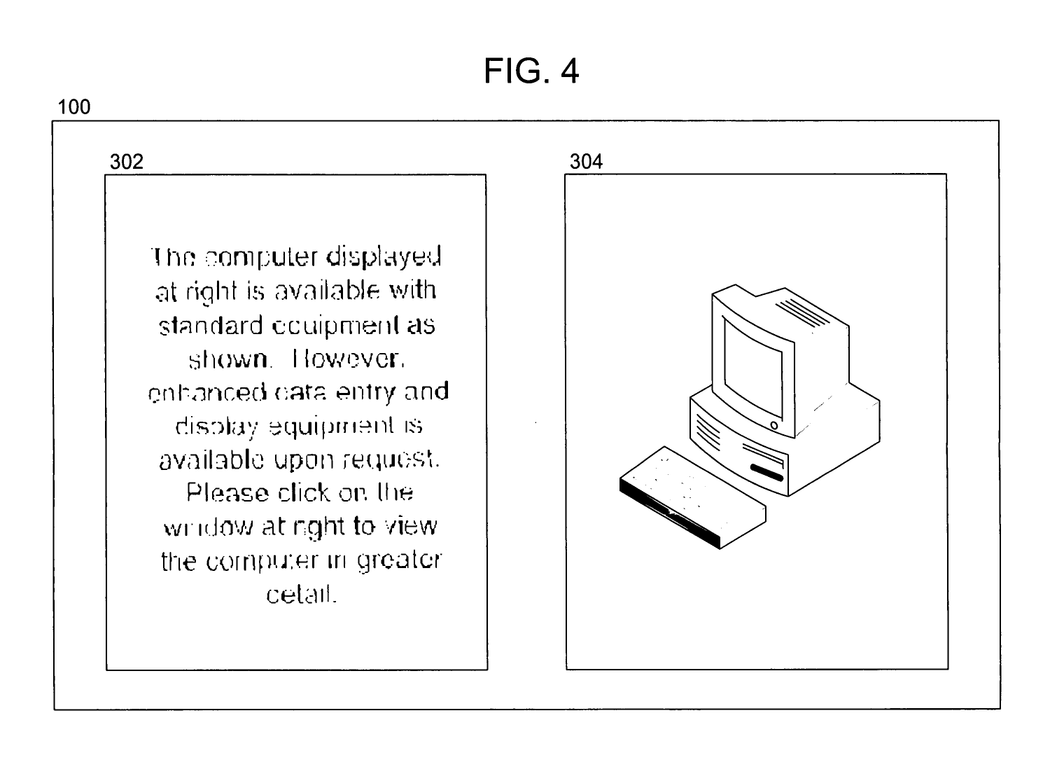

Reference is made to FIGS. 3 and 4 in the following. The diagrams of FIGS. 3 and 4 include visual effects to help illustrate one or more aspects of the present invention. FIG. 3 is an exemplary diagram of two windows 302, 304 within a computer display 100 in accordance with one or more embodiments of the present invention. The text and image of FIG. 3 may be employed in an advertisement for a computer or other related purpose. However, the text and image of FIG. 3 are merely illustrative, and the present invention is not limited by the possible uses of the text and image illustrated in FIG. 3 or by the actual content of the text.

Display 100 preferably includes windows 302 and 304. In FIG. 3, window 302, which includes text, is preferably active, while window 304, which includes an image of a computer, is preferably inactive. Preferably, the display characteristic of resolution is employed to distinguish the active state of window 302 from the inactive state of window 304. Thus, in FIG. 3, the text of window 302 is displayed with a high degree of resolution, while the image of the computer in window 304 is displayed with a low level of resolution.

Directing attention to FIG. 4, it may be seen that the image of the computer in window 304 is shown at high resolution, while the text in window 302 is shown at low resolution. Thus, in response to a user input, such as a computer mouse click, or other input, the activity status of window 304 has preferably transitioned from inactive to active, while the activity status of window 302 has preferably transitioned from active to inactive.

In the example of FIGS. 3 an 4, the display characteristic of resolution was employed to distinguish the active window from the inactive window within each figure. However, it will be appreciated by those of skill in the art that the invention is not so limited, and that one or more other display characteristics may be employed either in place of, or in addition to, resolution to distinguish between active and inactive windows.

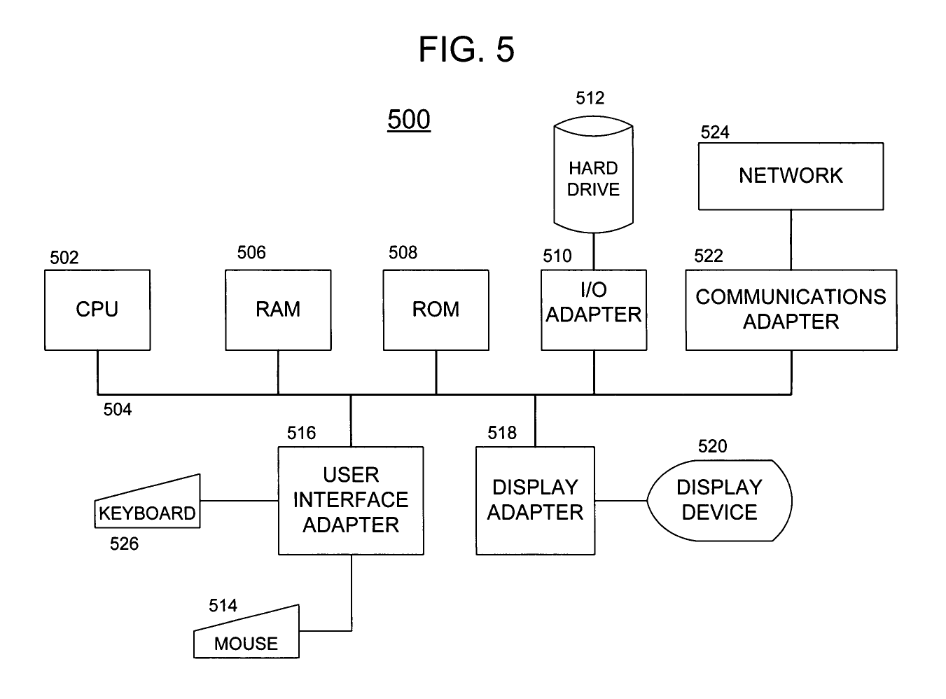

FIG. 5 is a block diagram of a computing system 500 adaptable for use with one or more embodiments of the present invention. In one or more embodiments, central processing unit (CPU) 502 may be coupled to bus 504. In addition, bus 504 may be coupled to random access memory (RAM) 506, read only memory (ROM) 508, input/output (I/O) adapter 510, communications adapter 522, user interface adapter 506, and display adapter 518.

In one or more embodiments, RAM 506 and/or ROM 508 may hold user data, system data, and/or programs. I/O adapter 510 may connect storage devices, such as hard drive 512, a CD-ROM (not shown), or other mass storage device to computing system 500. Communications adapter 522 may couple computing system 500 to a local, wide-area, or Internet network 524. User interface adapter 516 may couple user input devices, such as keyboard 526 and/or pointing device 514, to computing system 500. Moreover, display adapter 518 may be driven by CPU 502 to control the display on display device 520. CPU 502 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
providing a display operating within a computing system;
selecting at least one display characteristic to represent respective activity statuses of a plurality of windows present in said display, said at least one display characteristic including at least resolution; and
displaying said windows employing values of said at least one selected display characteristic corresponding to said windows' respective activity statuses.

2. The method of claim 1 wherein said at least one display characteristic further includes at least one characteristic selected from the group consisting of: contrast, brightness, color balance, and saturation.

3. The method of claim 1 further comprising:
increasing a value of said at least one display characteristic for a given one of said windows when an activity status of said given window transitions from inactive to active.

4. The method of claim 3 wherein said increasing comprises:
gradually increasing said value of said at least one display characteristic.

5. The method of claim 3 wherein said increasing said value of said at least one display characteristic comprises providing a high-resolution display of said given window.

6. The method of claim 1 further comprising:
reducing a value of said at least one display characteristic for a given one of said windows when an activity status of said given window transitions from active to inactive.

7. The method of claim 6 wherein said reducing comprises gradually reducing said value of said at least one display characteristic for said given one of said windows.

8. The method of claim 6 wherein said reducing comprises providing a low-resolution display of said given window.

9. The method of claim 6 wherein said providing a low-resolution display of said given window lowers a computational burden on said computing system imposed by said displaying.

10. A method, comprising:
providing a display operating within a computing system;
displaying a plurality of windows on said display, at least one of said windows being an active window;
making said at least one active window inactive;
reducing a display resolution of said at least one window upon said making said at least one window inactive.

11. The method of claim 10 further comprising:
maintaining said at least one window at said lowered resolution for as long as said at least one window is inactive.

12. The method of claim 10 wherein said reducing comprises gradually reducing said display resolution of said at least one window.

13. The method of claim 10 wherein said plurality of windows includes at least one initially inactive window.

14. The method of claim 13 further comprising:
making one of said at least one initially inactive window active; and
increasing a display resolution of said one window.

15. The method of claim 14 wherein said increasing comprises gradually increasing said display resolution of said one window.

16. The method of claim 10 further comprising:
discontinuing processing in an application program controlling said at least one deactivated window.

17. An apparatus, comprising:
a computing system having a display,
wherein said computing system is operable to
select at least one display characteristic to represent respective activity statuses of a plurality of windows present in said display, said at least one display characteristic including at least resolution; and
display said windows employing values of said at least one selected display characteristic corresponding to said windows' respective activity statuses.

18. The apparatus of claim 17 wherein said at least one display characteristic further includes at least one characteristic selected from the group consisting of: contrast, brightness, color balance, and saturation.

19. The apparatus of claim 17 wherein said computing system is further operable to:
increase a value of said at least one display characteristic for a given one of said windows when an activity status of said given window transitions from inactive to active.

20. The apparatus of claim 17 wherein said computing system is further operable to:
reduce a value of said at least one display characteristic for a given one of said windows when an activity status of said given window transitions from active to inactive.
